(19) United States
(12) Patent Application Publication
(10) Pub. No.: US 2012/0017224 A1
(43) Pub. Date: Jan. 19, 2012

(54) DISC PLAYER WITH LIGHT-SENSING TYPE LOADING MECHANISM

(76) Inventor: Hung-Chi Teng, Taichung (TW)

(21) Appl. No.: 12/838,217

(22) Filed: Jul. 16, 2010

(51) Int. Cl. G11B 7/00

(52) U.S. Cl. 720/689; G9B/7

(57) ABSTRACT

A disc player with light-sensing type loading mechanism includes a casing, a control board, a slide mechanism and a light-sensing element. The light-sensing element is adopted to serve as a switch controlling the slide mechanism to reciprocate between a loading area and a reading area. The disc to be loaded is detected by an optical manner instead of physical. The invention may increase durability of a disc player.

### BACKGROUND OF THE INVENTION

1. Technical Field

The invention generally relates to an optical disc drive, particularly to a slot-load optical disc drive.

2. Related Art

A slot-load blu-ray disc drive is shown in FIG. 1. The disc drive includes a casing 1, a pick-up assembly 2 and a slide mechanism 3. The casing 1 is provided with a slot at the front thereof. The pick-up assembly 2 mounted in the casing 1 is used for reading a loaded disc. The slide mechanism 3 mounted in the casing 1 can reciprocate along a predetermined path for loading a disc into a position at which the pick-up assembly 2 can read the disc or ejecting the loaded disc.

The slide mechanism 3 includes a sliding seat 4, two clamps 5 and a driving device 6. The clamps 5 are disposed on the sliding seat 4. The driving device 6 drives the sliding seat 4 to move in the casing 1. The driving device 6 electrically connects a switch 8 on the sliding seat 4 through a control board 7. When the sliding seat 4 is at a loading position and a user embeds a disc 9 into the slot as shown in FIG. 2, the disc 9 will be clamped between the clamps 5 and the sliding seat 4, and then the switch 8 will be pressed by the disc 9 and send a contact signal to the control board 7. After that, the control board 7 controls the driving device 6 to move the sliding seat 4, clamps 5 and disc 9 to a reading position for allowing the disc 9 to be read by the pick-up assembly 2.

However, employing the switch 8 to control the driving device 6 tends to give rise to a problem of positional slippage or coming off of the switch 8 because the switch 8 is moved with the sliding seat 4. Once this problem occurs, the disc 9 can not be loaded (i.e. the driving device 6 can not work). Also, another problem may happen after the disc drive has been used for a long time. That is the elastic fatigue of the switch 8 because the switch 8 is repeatedly pressed by the disc 9. Thus, loading of the disc 9 may be lagged.

### SUMMARY OF THE INVENTION

An object of the invention is to provide a disc player with a light-sensing loading mechanism, which can load or eject a disc very fast and precision.

Another object of the invention is to provide a disc player with a light-sensing loading mechanism, which can reduce abrasion of elements and prolong lifetime.

Accordingly, the invention provides an optical disc drive comprising a casing having a reading area and a loading area therein, provided with a slot communicating with the loading area and at least one first bump formed in the reading area; a control board mounted in the casing; a pick-up assembly for reading a disc, mounted in the reading area of the casing and electrically connected to the control board; a slide mechanism having a sliding seat, at least one clamp and a driving device, wherein the clamp is pivotally connected to the sliding seat through a free end towards the slot, the clamp is formed with at least one second bump, the driving device electrically connects to the control board for driving the sliding seat to reciprocate between the reading area and the loading area; and a light-sensing element mounted in the loading area of the casing, electrically connected to the control board; wherein when a disc is embedded into the slot, the disc will be clamped on the sliding seat by the at least one clamp, the light-sensing element will be triggered and send a signal to the control board to move the sliding seat from the loading area to the reading area, the at least one second bump touches the at least one first bump, and the at least one clamp is pushed to open.

According to the optical disc drive of the invention, wherein the casing further comprises a cover and a base.

According to the optical disc drive of the invention, wherein both sides of the casing are separately provided with two sliding rails, both sides of the sliding seat are separately provided with two sliding rods, one end of each the sliding rail is formed with an inclined rail, the sliding rods can move along the sliding rails and the inclined rails, when the sliding rods are located in the inclined rails, the at least one second bump touches the at least one first bump, and the free end of the at least one clamp is pushed to open.

According to the optical disc drive of the invention, wherein the pick-up assembly further comprises a frame, a pick-up head and a spindle motor, the pick-up head is mounted on the frame and driven to reciprocate along the frame in the reading area, and the spindle motor is mounted on the frame for rotating the disc.

According to the optical disc drive of the invention, wherein the sliding seat is provided with at least one through hole, the at least one second bump penetrates through the through hole.

According to the optical disc drive of the invention, wherein the driving device further comprises a driving motor, a gear set, a rack disposed on the sliding seat and a wheel-belt set, the driving motor is mounted in the casing for providing power to the sliding seat via the wheel-belt set, the gear set and the rack, and the sliding seat is capable of moving between the reading area and the loading area.

Therefore, the invention employs the light-sensing element to control motion of the slide mechanism. Damages resulting from physical wear and tear can be effectively prevented. Not only can the sliding seat move smoothly, but also the disc can be clamped accurately. This will make the reading process more unhindered.

### BRIEF DESCRIPTION OF THE DRAWINGS

FIG. 1 is an exploded perspective view of a conventional disc player;

FIG. 2 is an assembled top view of the conventional disc player shown in FIG. 1;

FIG. 3 is an exploded perspective view of the invention;

FIG. 4 is an assembled perspective view of the invention; and

FIGS. 5-8 show a series of motions of the invention.

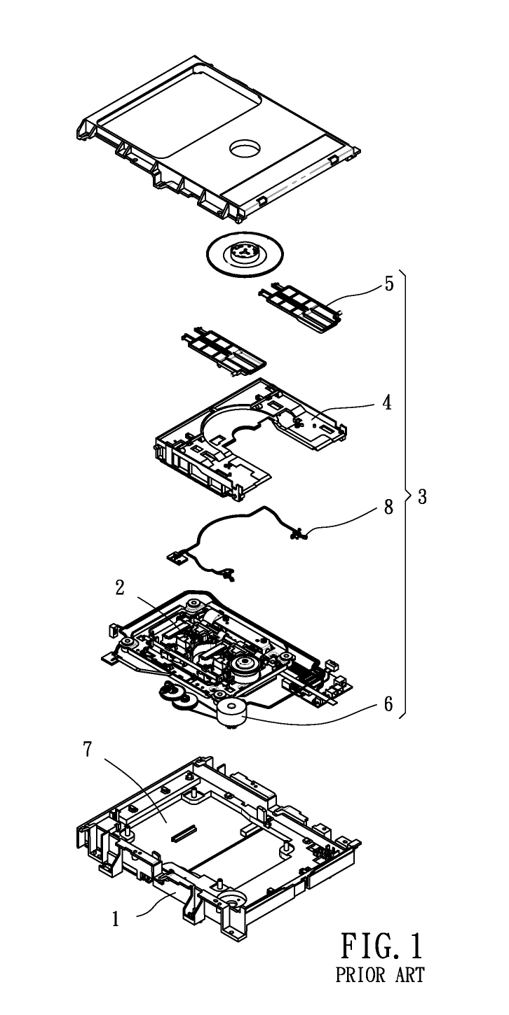

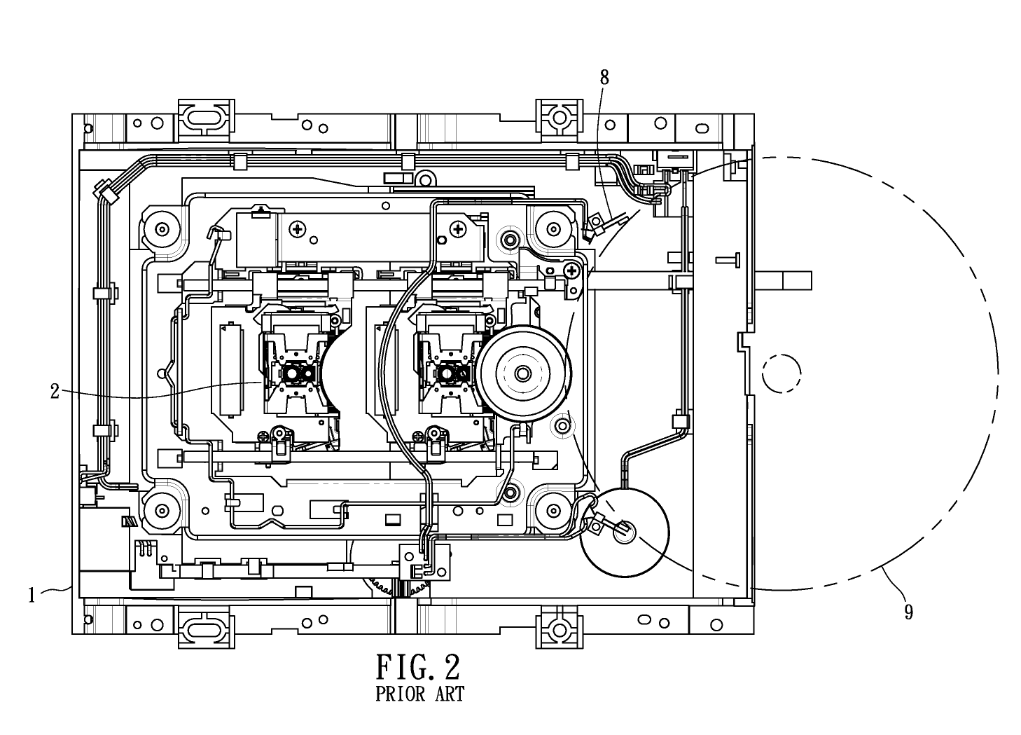

### DETAILED DESCRIPTION OF THE INVENTION

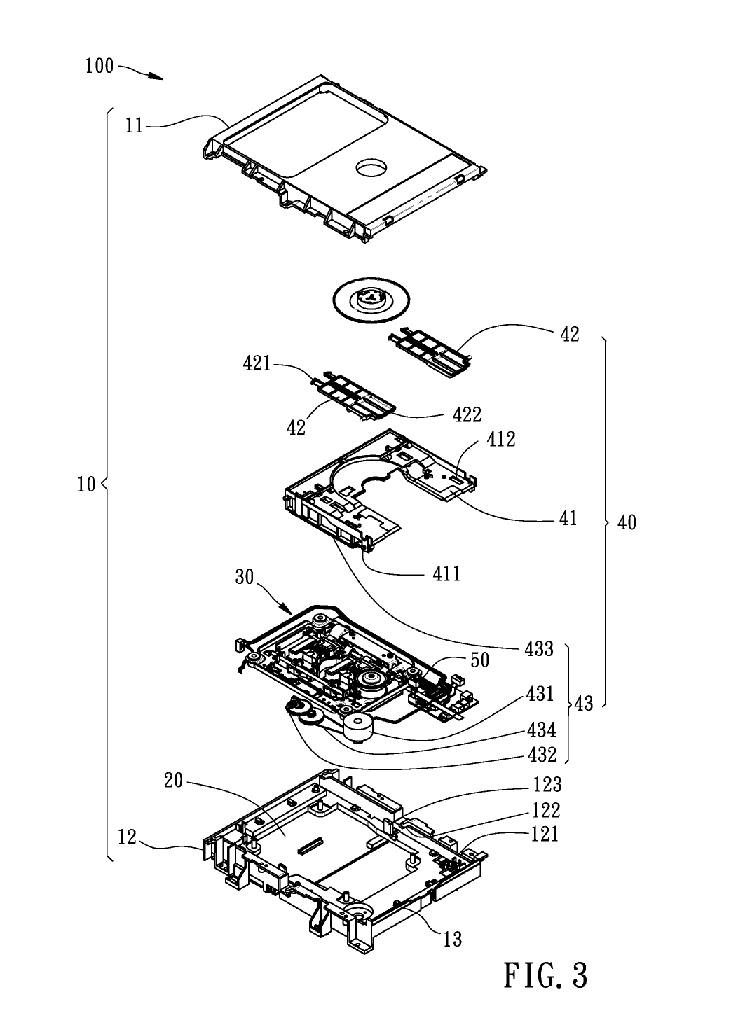

Please refer to FIGS. 3-8. A preferred embodiment of the invention provides a blu-ray disc player with a light-sensing loading mechanism including a casing 10, a control board 20, a pick-up assembly 30, a slide mechanism 40 and a light-sensing element 50.

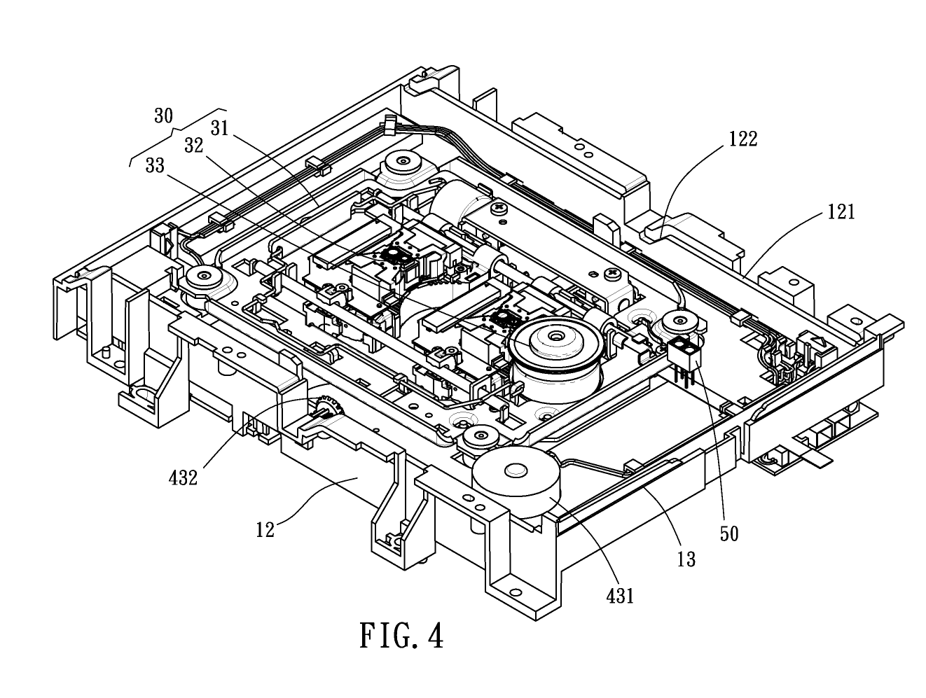

Please refer to FIGS. 3 and 4. The casing 10 serves to be mounted by the control board 20, pick-up assembly 30, slide mechanism 40 and light-sensing element 50. The casing 10 is composed of a cover 11 and a base 12. The casing 10 is provided with a slot 13 at the front thereof for being embedded by a disc. Both sides of the base 12 of the casing 10 are separately provided with two sliding rails 121 and two first bumps 123. One end of each the sliding rail 121 is formed with an inclined rail 122. A reading area and a loading area are defined in the casing 10. The first bumps 123 and slot 13 are located in the reading area and loading area, respectively.

Please refer to FIG. 3. The control board 20 is mounted in the casing 10 and electrically connected to the pick-up assembly, slide mechanism 40 and light-sensing element 50 for controlling them.

Please refer to FIGS. 3 and 4. The pick-up assembly 30 includes a frame 31, a pick-up head 32 and a spindle motor 33. The pick-up assembly 30 is mounted in the casing 10 and the pick-up head 32 is mounted on the frame 31. The pick-up head 32 may be driven to reciprocate along the frame 31 in the reading area. The spindle motor 33 is mounted on the frame 31 for rotating the disc.

Please refer to FIGS. 3 and 6-8. The slide mechanism 40 includes a sliding seat 41, two clamps 42 and a driving device 43. Both sides of the sliding seat 41 are separately provided with two sliding rods 411. Each of the clamps 42 is pivotally connected to the sliding seat 41 through a free end 422 towards the slot 13. Each of the clamps 42 is formed with a second bump 423 penetrating through a through hole 412 of the sliding seat 41. The driving device 43 includes a driving motor 431, a gear set 432, a rack 433 disposed on the sliding seat 41 and a wheel-belt set 434. The driving motor 431 is mounted in the casing 10 for providing power to the sliding seat 41 via the wheel-belt set 434, gear set 432 and rack 433. As a result, the sliding seat 41 is capable of moving along the sliding rail 121 and inclined rail 122 by the sliding rod 411.

Please refer to FIG. 4. The light-sensing element 50 is mounted in the loading area of the casing 10 and can detect movement of a disc placed in the loading area by a non-contact manner.

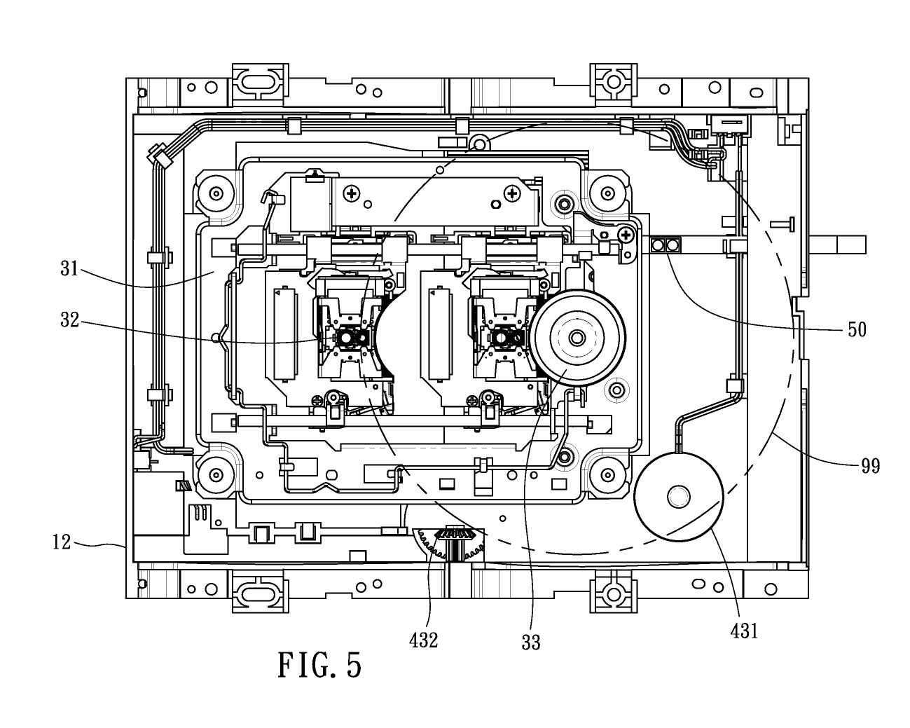

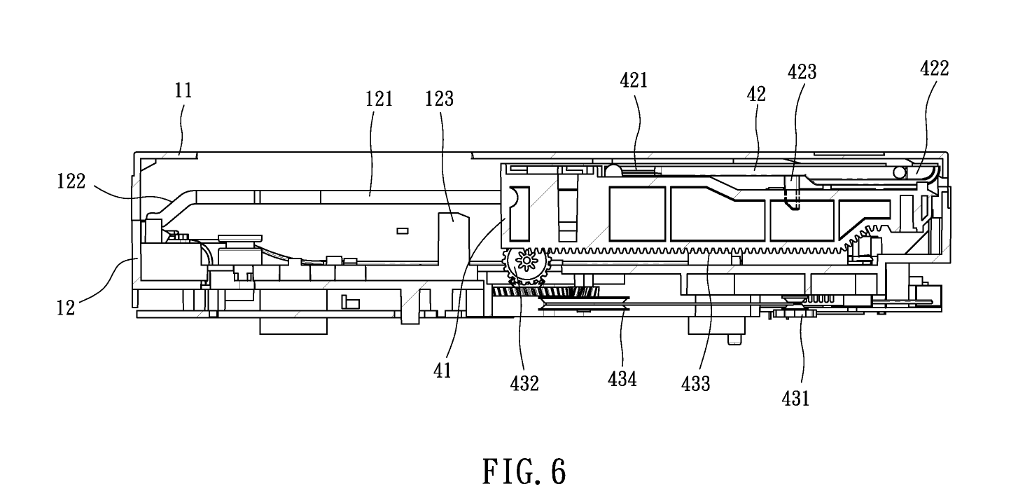

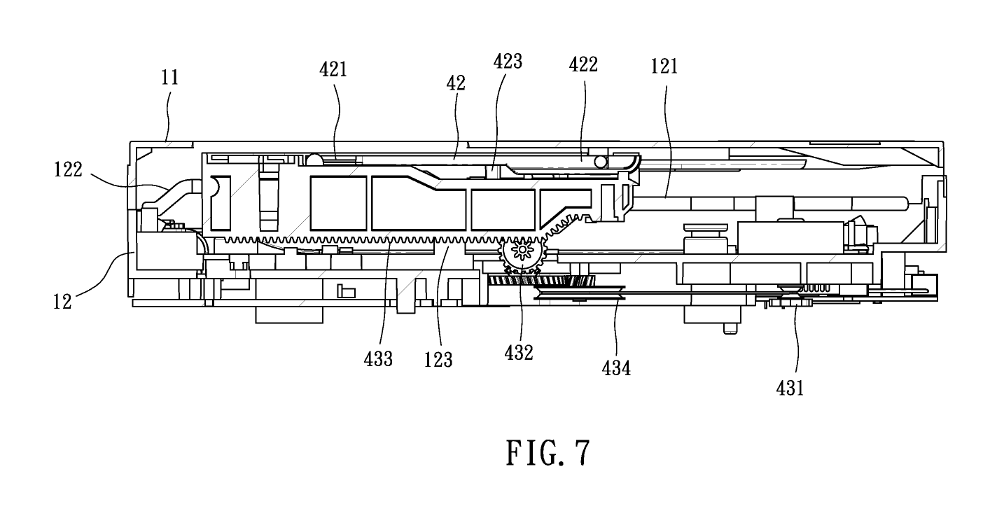

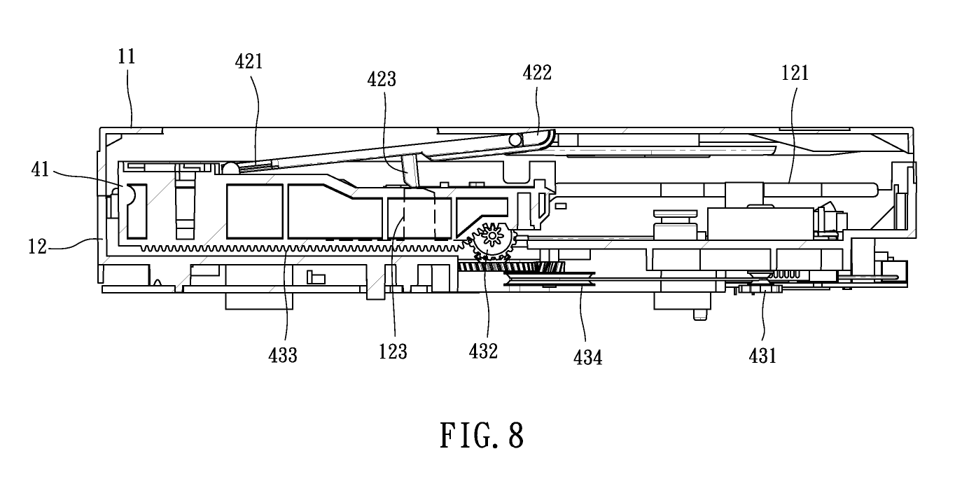

Please further refer to FIG. 5. When a user embeds a disc 99 into the slot 13 of the casing 10, the disc 99 will be clamped on the sliding seat 41 by the clamps 42. Meanwhile, once the disc 99 enters the loading area, the light-sensing element 50 will be triggered and send a signal to the control board 20. Then the control board 20 controls the driving motor 431 to move the sliding seat 41 via the wheel-belt set 434, gear set 432 and rack 433. Thus, the sliding seat 41 moves along the sliding rail 121 and the disc 99 is moved from the loading area to the reading area as shown in FIGS. 6 and 7. After the sliding rods 411 of the sliding seat 41 slides into the inclined rails 122, the sliding seat 41 will slightly move downwards to make the second bumps 423 of the clamps 42 touch the first bumps 123 of the casing 10. Then the clamps 42 are pushed to open as shown in FIG. 8. Thus, the disc 99 is put on the spindle motor 33 to be rotated for being read by the pick-up head 32.

The invention employs the light-sensing element to control motion of the slide mechanism. Damages resulting from physical wear and tear can be effectively prevented. Not only can the sliding seat move smoothly, but also the disc can be clamped accurately. This will make the reading process more unhindered.

While the forgoing is directed to a preferred embodiment of the present invention, other and further embodiments of the invention may be devised without departing from the basic scope thereof. As such, the appropriate scope of the invention is to be determined according to the claims.

What is claimed is:

1. An optical disc drive comprising:
a casing having a reading area and a loading area therein, provided with a slot communicating with the loading area and at least one first bump formed in the reading area;
a control board mounted in the casing;
a pick-up assembly for reading a disc, mounted in the reading area of the casing and electrically connected to the control board;
a slide mechanism having a sliding seat, at least one clamp and a driving device, wherein the clamp is pivotally connected to the sliding seat through a free end towards the slot, the clamp is formed with at least one second bump, the driving device electrically connects to the control board for driving the sliding seat to reciprocate between the reading area and the loading area; and
a light-sensing element mounted in the loading area of the casing, electrically connected to the control board;
wherein when a disc is embedded into the slot, the disc will be clamped on the sliding seat by the at least one clamp, the light-sensing element will be triggered and send a signal to the control board to move the sliding seat from the loading area to the reading area, the at least one second bump touches the at least one first bump, and the at least one clamp is pushed to open.

2. The optical disc drive of claim 1, wherein the casing further comprises a cover and a base.

3. The optical disc drive of claim 1, wherein both sides of the casing are separately provided with two sliding rails, both sides of the sliding seat are separately provided with two sliding rods, one end of each the sliding rail is formed with an inclined rail, the sliding rods can move along the sliding rails and the inclined rails, when the sliding rods are located in the inclined rails, the at least one second bump touches the at least one first bump, and the free end of the at least one clamp is pushed to open.

4. The optical disc drive of claim 1, wherein the pick-up assembly further comprises a frame, a pick-up head and a spindle motor, the pick-up head is mounted on the frame and driven to reciprocate along the frame in the reading area, and the spindle motor is mounted on the frame for rotating the disc.

5. The optical disc drive of claim 1, wherein the sliding seat is provided with at least one through hole, the at least one second bump penetrates through the through hole.

6. The optical disc drive of claim 1, wherein the driving device further comprises a driving motor, a gear set, a rack disposed on the sliding seat and a wheel-belt set, the driving motor is mounted in the casing for providing power to the sliding seat via the wheel-belt set, the gear set and the rack, and the sliding seat is capable of moving between the reading area and the loading area.
